(19) United States
(12) Patent Application Publication
(10) Pub. No.: US 2026/0029305 A1
(43) Pub. Date: Jan. 29, 2026

(54) OPTICAL MONITOR DEVICE AND OPTICAL INTENSITY MEASUREMENT METHOD

(71) Applicant: NIPPON TELEGRAPH AND TELEPHONE CORPORATION, Tokyo (JP)

(72) Inventors: Ryo KOYAMA, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/995,012

(22) PCT Filed: Jul. 28, 2022
(86) PCT No.: PCT/JP2022/029145

§ 371 Date: Jan. 15, 2025

(51) Int. Cl. G01M 11/00

(52) U.S. Cl. CPC G01M 11/35

(57) ABSTRACT

An object of the present disclosure is to enable simultaneous measurement of light intensities of a plurality of optical fibers arranged in a tape-like form.

The present disclosure is an optical monitor device including: a bend applying portion that provides a bent portion on a tape core wire in which the plurality of optical fibers is arranged in a row in a tape-like form, and a light receiving portion that receives a part of leaked light leaked from a bent portion of the tape core wire, in which in the light receiving portion, light receiving elements larger in number than the optical fibers are two-dimensionally arranged on a light receiving surface.

### TECHNICAL FIELD

The present disclosure relates to an optical monitor device, and particularly relates to an optical monitor device for detecting an intensity of light and feeding back a detection result to other components in an optical transmission device or the like.

### BACKGROUND ART

With an increase in Internet traffic, it is strongly required to increase a communication capacity in a communication system in recent years. In order to implement this, a communication system using optical fibers is used in an access network between a communication station building and a user's home or a core network connecting communication station buildings. In optical fiber communication, detection of a light intensity propagating through an optical fiber is often used for controlling communication and checking soundness of equipment. For example, in an access network, test light is propagated through optical fibers, and a loss and soundness of the optical fibers, a core target, connection, and the like are checked from detection of the light intensity.

In light intensity monitoring of an access network, for example, a technology described in Patent Literature 1 is used. Patent Literature 1 describes a technology in which optical fibers are bent to leak propagated light, and communication of the optical fibers is checked, thereby enabling connection check of the optical fibers and intensity measurement of optical signals in the optical fibers in an access network.

However, an optical monitor device having the conventional arrangement configuration still has the following issues. First, while optical communication has become widespread and the number of optical fibers in an optical facility/optical cable has increased, a tape core wire in which a plurality of optical fibers is arranged in a row in a tape-like form has been widely used. However, in the technology of Patent Literature 1, optical fibers can only be measured one by one. In order to simultaneously measure a plurality of optical fibers being simultaneously used, it is necessary to separate the optical fibers into single fibers.

### CITATION LIST

### Patent Literature

Patent Literature 1: JP H07-078567 B

### SUMMARY OF INVENTION

### Technical Problem

The present disclosure has been made in view of such points, and an object of the present disclosure is to enable simultaneous measurement of light intensities of a plurality of optical fibers arranged in a tape-like form.

### Solution to Problem

An optical monitor device of the present disclosure is
an optical monitor device that detects an intensity of light propagating through a plurality of optical fibers, the optical monitor device including:
a bend applying portion that provides a bent portion on a tape core wire in which the plurality of optical fibers is arranged in a row in a tape-like form; and
a light receiving portion that receives a part of communication light leaked from a bent portion of the tape core wire,
in which light receiving elements larger in number than the optical fibers are two-dimensionally arranged on a light receiving surface of the light receiving portion.

A light intensity measurement method of the present disclosure is
a light intensity measurement method for collectively measuring intensities of light propagating through a plurality of optical fibers using the optical monitor device of the present disclosure, the light intensity measurement method including:
acquiring in advance correspondence relationships between the plurality of optical fibers and each light receiving element by measuring a received light intensity at each light receiving element when light is emitted by each optical fiber from the plurality of optical fibers;
detecting a light intensity of each light receiving element received by the light receiving portion in a state where the plurality of optical fibers is propagating light to be measured for an intensity; and
measuring at least one of
   (i) a light intensity of propagated light before passing through the bent portion, or
   (ii) a light intensity of propagated light after passing through the bent portion
for each of the optical fibers on a basis of the correspondence relationships.

### Advantageous Effects of Invention

According to the present disclosure, since light is received using a light receiving portion in which light receiving elements larger in number than optical fibers are two-dimensionally arranged on a light receiving surface, it is possible to implement an optical monitor device capable of simultaneously measuring light intensities of a plurality of optical fibers arranged in a tape-like form.

### BRIEF DESCRIPTION OF DRAWINGS

FIG. 1 illustrates a configuration example of an optical monitor device of the present embodiment.

FIG. 2 illustrates an example of images by leaked light from respective optical fibers received by a light receiving surface.

FIG. 3 illustrates an example of a measurement system for measuring correspondence relationships between each optical fiber and light receiving elements.

FIG. 4 illustrates an example of a measurement system for measuring light intensities of leaked light of communication light propagating through a tape core wire.

FIG. 5 illustrates an example of a measurement system for measuring correspondence relationships between each optical fiber and light receiving elements.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be implemented in a form with various modifications and improvements on the basis of the knowledge of those skilled in the art. Note that components having the same reference signs in the present specification and the drawings indicate the same components.

### First Exemplary Embodiment

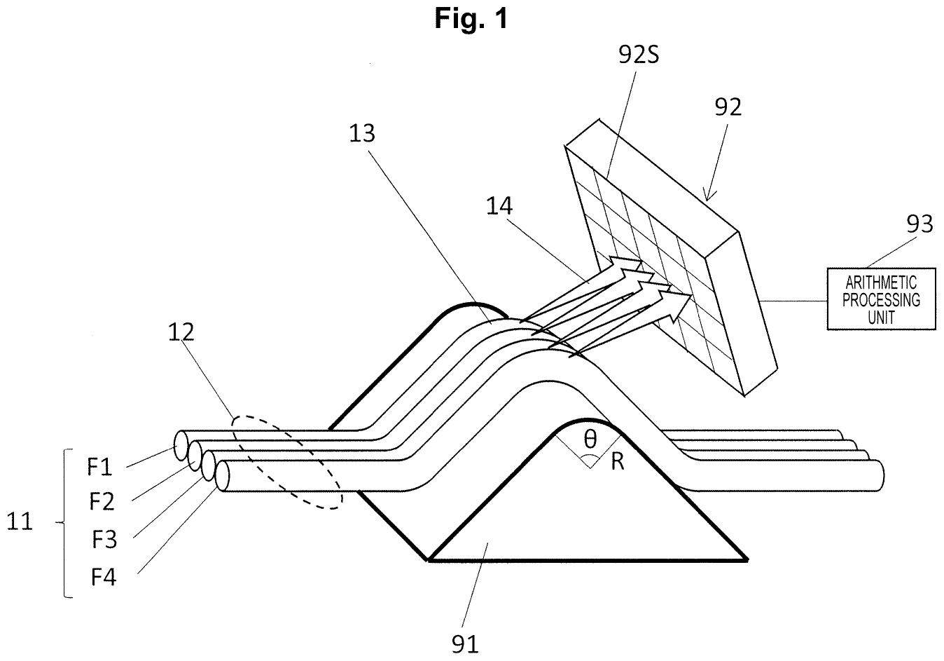

An optical monitor device of the present embodiment has a configuration illustrated in FIG. 1. The optical monitor device of the present embodiment is an optical monitor device that detects an intensity of light propagating through a plurality of optical fibers 11. In the present embodiment, an example is illustrated in which the plurality of optical fibers 11 is a tape core wire 12 in which M=4 optical fibers 11 are arranged in a row in a tape-like form. Hereinafter, when the four optical fibers 11 are distinguished, they are referred to as F1 to F4.

The optical monitor device of the present embodiment includes:
a bend applying portion 91 that provides a bent portion 13 on the tape core wire 12;
a light receiving portion 92 that receives leaked light 14 leaked from a bent portion 13 of the tape core wire 12; and
an arithmetic processing unit 93 that calculates a light intensity of propagated light of an optical fiber 11 before or after passing through the bent portion 13 using a light intensity of the leaked light 14 received by the light receiving portion 92.

The bend applying portion 91 bends the optical fibers 11 using a predetermined bending radius R. The bending radius R is any angle at which the leaked light 14 leaks from the optical fibers 11.

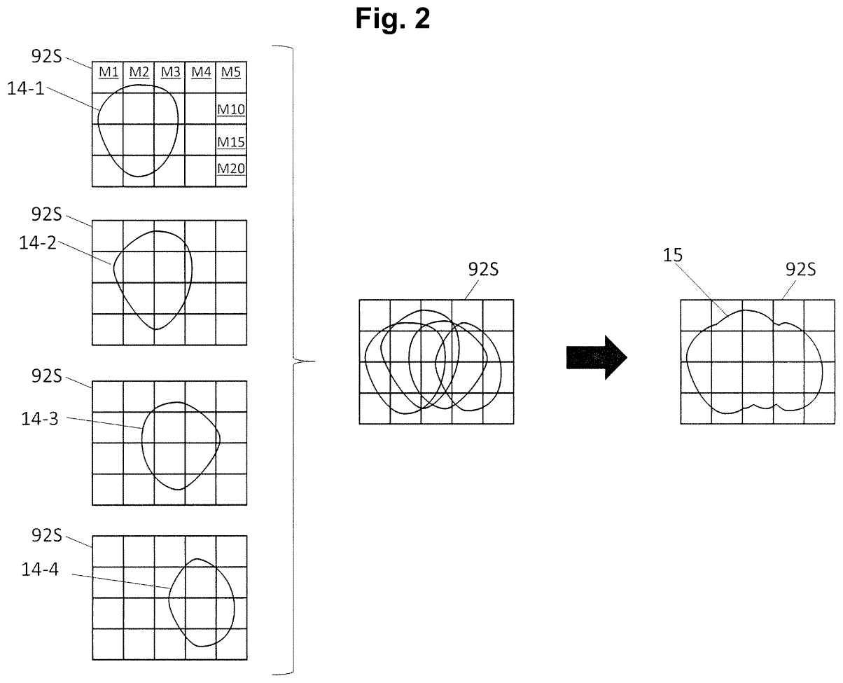

FIG. 2 illustrates images by leaked light of respective optical fibers F1 to F4 of a light receiving surface 92S and an image by pieces of leaked light 14-1 to 14-4 of all the optical fibers 11 when the number of fibers of the tape core wire 12 is four as an example. This drawing illustrates an example in which N=20 light receiving elements M1 to M20 are two-dimensionally arranged in 5×4 on the light receiving surface 92S. As described above, in the light receiving portion 92 of the present disclosure, light receiving elements larger in number than the optical fibers 11 are two-dimensionally arranged on the light receiving surface 92S. As illustrated in FIG. 2, an image 15 of the pieces of leaked light 14-1 to 14-4 of all the optical fibers 11 is indicated by the sum of the pieces of leaked light 14-1 to 14-4 of the respective optical fibers F1 to F4.

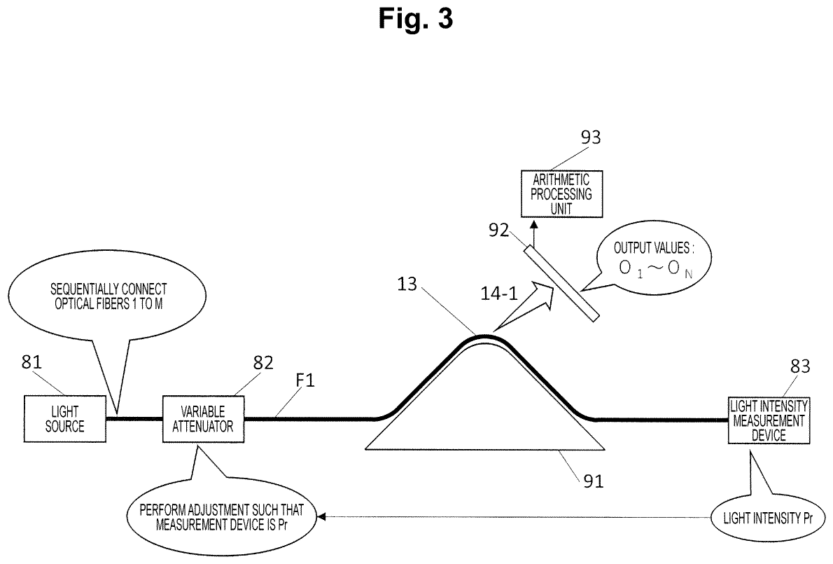

Therefore, in the present disclosure, light intensities of the leaked light in respective light receiving elements M1 to MN when the light intensity after passing from an optical fiber F1 through the bent portion 13 is a predetermined reference intensity Pr are measured in advance and recorded in the arithmetic processing unit 93. The measurement system for this recording is illustrated in FIG. 3.

Specifically, the tape core wire 12 is installed in the bend applying portion 91, the optical fiber F1 is connected to a light source 81 and a light intensity measurement device 83, light is made incident on the optical fiber F1 from the light source 81, and the light receiving portion 92 receives a piece of leaked light 14-1. On the basis of the light intensity measured by the light intensity measurement device 83, the light intensity incident on the optical fiber F1 is adjusted using a variable attenuator 82 such that the light intensity after passing through the bent portion 13 is the reference intensity Pr. As a result, the arithmetic processing unit 93 can acquire correspondence relationships Or₁₁ to Or_{1N} between the optical fiber F1 and the light receiving elements M1 to MN. Similarly for optical fibers F2 to FM, the arithmetic processing unit 93 records correspondence relationships Or₂₁ to Or_{MN} between the optical fibers F2 to FM and the light receiving elements M1 to MN.

The correspondence relationships between the optical fibers F1 to FM and the light receiving elements M1 to MN can be expressed as follows.

$$\begin{matrix}[ Math . 1 ] & \\ ( \begin{matrix}{Or}_{11} & ⋯ & {Or}_{M 1} \\ ⋮ & ⋱ & ⋮ \\ {Or}_{1 N} & ⋯ & {Or}_{MN}\end{matrix} ) & ( Formula 1 )\end{matrix}$$

Here, Orᵢⱼ is a light intensity received by the j-th light receiving element included in the light receiving portion 92 when light is emitted from the i-th optical fiber among the optical fibers F1 to FM.

Since the light intensity of the leaked light 14 from the tape core wire 12 is not changed so much depending on the type of the tape core wire 12, the correspondence relationships Or₁₁ to Or_{1N} can be referred to by measurement in the field if the correspondence relationships Or₁₁ to Or_{1N} are acquired once. Note that the correspondence relationships Or₁₁ to Or_{1N} according to the type of the tape core wire 12 may be acquired so that the correspondence relationships Or₁₁ to Or_{1N} can be selected for each type of the tape core wire 12.

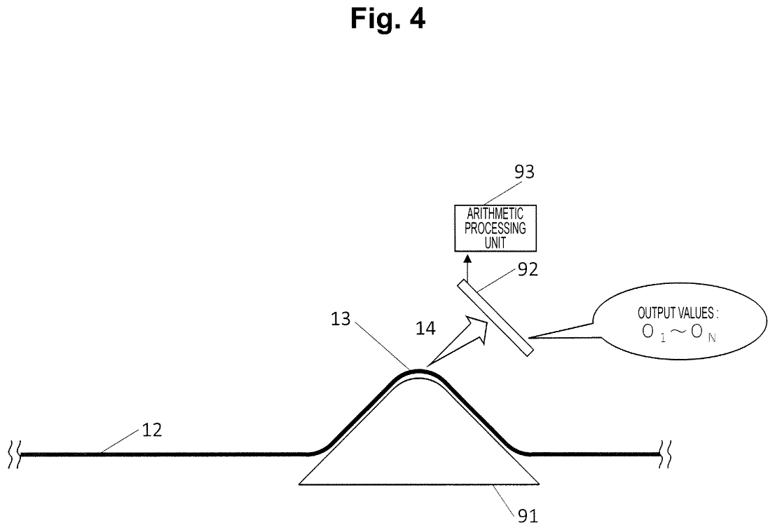

Next, a measurement system when actual measurement is performed is illustrated in FIG. 4. Assuming that the light intensities of light propagating through the optical fibers F1 to FM after passing through the bent portion 13 are k₁ to k_{M} respective times the reference intensity Pr, light intensities O₁ to O_{N} of leaked light detected by the respective light receiving elements M1 to MN are the sums of light made incident from the respective optical fibers F1 to FM, and thus are expressed as Formula 2.

$$\begin{matrix}[ Math . 2 ] & \\ ( \begin{matrix}{O}_{1} \\ ⋮ \\ {O}_{N}\end{matrix} ) = ( \begin{matrix}{Or}_{11} & ⋯ & {Or}_{M 1} \\ ⋮ & ⋱ & ⋮ \\ {Or}_{1 N} & ⋯ & {Or}_{MN}\end{matrix} ) ( \begin{matrix}{k}_{1} \\ ⋮ \\ {k}_{M}\end{matrix} ) & ( Formula 2 )\end{matrix}$$

Therefore, the light intensities of light propagated through the respective optical fibers F1 to FM after passing through the bent portion 13 can be calculated by Formula 3.

$$\begin{matrix}[ Math . 3 ] & \\ Pr ( \begin{matrix}{k}_{1} \\ ⋮ \\ {k}_{M}\end{matrix} ) = Pr {( \begin{matrix}{Or}_{11} & ⋯ & {Or}_{M 1} \\ ⋮ & ⋱ & ⋮ \\ {Or}_{1 N} & ⋯ & {Or}_{MN}\end{matrix} )}^{+} ( \begin{matrix}{O}_{1} \\ ⋮ \\ {O}_{N}\end{matrix} ) & ( Formula 3 )\end{matrix}$$

Provided that the subscript “+” at the upper right of a matrix represents a generalized inverse matrix.

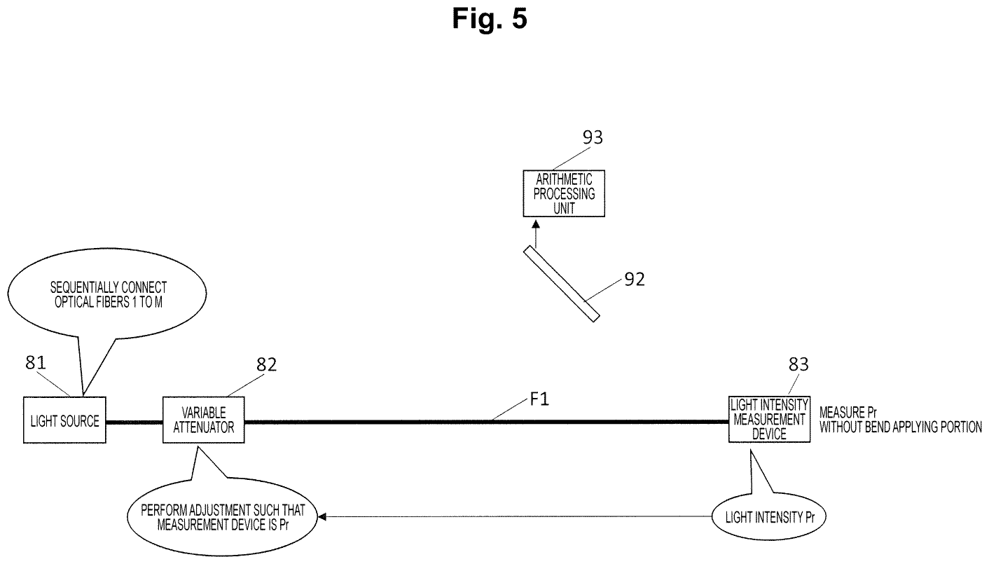

When the light intensity measured by the intensity measurement device 83 is the reference intensity Pr, in a case where the tape core wire 12 is removed from the bend applying portion 91 as illustrated in FIG. 5 and Or₁₁ to Or_{1N} are recorded, the light intensity of light propagating through the optical fiber F1 before passing through the bent portion 13 can be measured. Similarly for the optical fibers F2 to FM, the correspondence relationships Or₂₁ to Or_{MN} between the optical fibers F2 to FM before passing through the bent portion 13 and the light receiving elements M1 to MN are recorded. As a result, it is possible to acquire the correspondence relationships corresponding to Formula 1 in a case of measuring a light intensity before passing through the bent portion 13. By using these correspondence relationships in Formula 3, the light intensity of propagated light before passing through the bent portion 13 can be calculated.

A light intensity measurement method of the present disclosure includes:
acquiring in advance correspondence relationships expressed by Formula 1;
detecting a light intensity using the light receiving portion 92 using Formula 3 in a state in which an optical fiber 11 propagates light to be measured for an intensity; and
measuring at least one of
   (i) a light intensity of propagated light before passing through the bent portion 13, or
   (ii) a light intensity of propagated light after passing through the bent portion 13
for each of the optical fibers F1 to FM on the basis of the correspondence relationships.

In the present embodiment, the correspondence relationships between the optical fibers 11 and the light receiving elements M1 to MN are acquired in advance. Therefore, it is possible to collectively measure intensities of any light propagating through the optical fibers 11, such as communication light or test light, on the basis of the correspondence relationships.

The optical monitor device of the present disclosure can be used for monitoring any light transmitted in an optical transmission system. For example, the optical monitor device of the present disclosure can be incorporated in any device used in an optical transmission system such as a transmission device, a reception device, or a relay device, and a measurement result in the light receiving portion 92 can be used for feedback or feedforward to any component inside or outside the device. Furthermore, the optical monitor device of the present disclosure can be inserted in the middle of a transmission line in an optical transmission system so as to measure the intensity and a propagation loss of an optical signal in the transmission line.

Although the example has been described in which the number M of the optical fibers 11 is four in the optical monitor device of the present embodiment, the number M of the optical fibers 11 may be any number of two or more. When actual measurement is performed, the number M of the optical fibers 11 is set, and the tape core wire 12 is installed at a position on the bend applying portion 91 determined according to the number M. Thus, a light intensity of any number of tape core wires 12 can be measured.

In the present embodiment, the example has been described in which the propagation direction of propagated light of the optical fibers 11 is unidirectional, but the propagation direction of the propagated light of the optical fibers 11 may be both directions. In this case, the light receiving portion 92 that receives the leaked light 14 is arranged on both sides of the bent portion 13, and the correspondence relationships expressed by Formula 1 are acquired in advance for each of the directions.

The shape of the bend applying portion 91 is any shape, but for example, as illustrated in FIG. 1, the bending radius R may be formed over an angle θ of less than 180 degrees, and both ends of the bend applying portion 91 may be flat surfaces. The configuration in which the tape core wire 12 is made to run along the bend applying portion 91 is any configuration, and a member that presses the tape core wire 12 against the bend applying portion 91 may be used, or the tape core wire 12 may be wound around the bend applying portion 91.

In the present embodiment, each configuration included in the optical monitor device has been described, but the bend applying portion 91, the light receiving portion 92, and the arithmetic processing unit 93 included in the optical monitor device may be accommodated in one housing. The arithmetic processing unit 93 included in the light receiving portion 92 may be used.

The arithmetic processing unit 93 of the present disclosure can also be implemented by a computer and a program, and the program can be recorded in a recording medium or provided through a network. A program of the present disclosure is a program for causing a computer to be implemented as the arithmetic processing unit 93 and is a program for causing a computer to execute each step included in a method to be executed by the arithmetic processing unit 93.

### INDUSTRIAL APPLICABILITY

The present disclosure can be applied to information and communication industries.

### REFERENCE SIGNS LIST

11 Optical fiber
12 Tape core wire
13 Bent portion
14, 14-1 to 14-4 Leaked light
81 Light source
82 Variable attenuator
83 Light intensity measurement device
91 Bend applying portion
92 Light receiving portion
92S Light receiving surface
93 Arithmetic processing unit

1. An optical monitor device that detects an intensity of light propagating through a plurality of optical fibers, the optical monitor device comprising:
a bend applying portion that provides a bent portion on a tape core wire in which the plurality of optical fibers is arranged in a row in a tape-like form; and
a light receiving portion that receives a part of leaked light leaked from a bent portion of the tape core wire,
wherein in the light receiving portion, light receiving elements larger in number than the optical fibers are two-dimensionally arranged on a light receiving surface.

2. A light intensity measurement method for collectively measuring intensities of light propagating through a plurality of optical fibers using the optical monitor device according to claim 1, the light intensity measurement method comprising:
acquiring in advance correspondence relationships between the plurality of optical fibers and each light receiving element by measuring a received light intensity at each light receiving element when light is emitted by each optical fiber from the plurality of optical fibers;
detecting a light intensity of each light receiving element received by the light receiving portion in a state where the plurality of optical fibers is propagating light to be measured for an intensity; and
measuring at least one of
(i) a light intensity of propagated light before passing through the bent portion, or
(ii) a light intensity of propagated light after passing through the bent portion for each of the optical fibers on a basis of the correspondence relationships.
